(19) United States
(12) Patent Application Publication
(10) Pub. No.: US 2016/0301713 A1
(43) Pub. Date: Oct. 13, 2016

(54) SYSTEM AND METHOD FOR ESTABLISHING SECURE INTERNET COMMUNICATION CHANNEL FOR AUTHENTICATION FROM A WEB BROWSER

(71) Applicant: ID Security, LLC, Machester, MA (US)

(72) Inventor: Srivathsan Krishnamachari, Newton, MA (US)

(21) Appl. No.: 15/094,170

(22) Filed: Apr. 8, 2016

Related U.S. Application Data
(60) Provisional application No. 62/145,807, filed on Apr. 10, 2015.

(51) Int. Cl. H04L 29/06

(52) U.S. Cl. CPC H04L 63/18; H04L 63/0442; H04L 63/08

(57) ABSTRACT

A system and method are provided for establishing a secondary communication channel of communication in the background without explicit user interaction to authenticate the user trying to access resources on a server and the secondary communication channel is triggered by a specially crafted extension in a user accessed URL.

### RELATED APPLICATIONS

This application claims priority to U.S. Provisional Application Ser. No. 62/145,807, filed on Apr. 10 2015 entitled “SYSTEM AND METHOD FOR ESTABLISHING SECURE INTERNET COMMUNICATION CHANNEL FOR AUTHENTICATION FROM A WEB BROWSER”, the entirety of which is incorporated by reference herein.

### FIELD

The present inventive concepts relate generally to internet security, and more specifically are directed to an establishment of a secure out-of-band communication channel between a service provider and a client computer system by using the client's browser to initiate the process that performs authentication using a secondary channel outside that web browser.

### BACKGROUND

Authentication with a service provider's secured computer, server, database, and/or other electronic device normally involves providing a user name and password combination at the provider's web site. Some service providers such as banks or other financial institutions may require additional or complementary authentication schemes including encryption. The username and password are communicated to the provider using an encrypted channel. Despite an encrypted communication, the password can be compromised in multiple ways: malware in the browser, phishing attacks, hacking, and so on.

Many providers support a two-level authentication by sending a computer-generated secret code, for example, a sequence of digits, to be used along with the password to a preregistered phone, email address, or a secure key. This additional authentication may render the authentication cumbersome. For example, in order to receive the secret code on a registered mobile smartphone, the smartphone must be connected to a cellphone service provider's network. However, the cellphone may be out of the network or otherwise might not be available, especially while the user is travelling. Receiving a secret code via email requires a login into the email server in a browser over potentially unsafe network connection. Any secure authentication data stream involving a client browser may present additional security problems.

### SUMMARY

Interactions between a browser and the web may be handled via Uniform Resource Identifiers (URIs). A URI is a well-known character string that identifies a resource. Users are generally familiar with the URI called a Uniform Resource Locator (URL)—the web address. URIs can denote special schemes to indicate actions to take, such as file transfer protocol (ftp), to initiate a file transfer. Browsers are designed to handle many schemes within the browser, such as HTTP (HyperText Transfer Protocol) to render a web page. Other schemes may be handled by software applications other than the web browser itself, for example, a Skype™ scheme. Here, if a user has installed a Skype conferencing application, when executed by a computer processor, the Skype™ application will register to process Skype™ schemes. Activating a web link that contains a Skype™ scheme will result in the Skype™ application being started and then processing the URI. Skype™ URI links make it easy for people to call a user from a Skype™ service.

Embodiments of the present inventive concepts include a computer-executed special scheme for processing a string of characters such as URIs used to identify a resource over the world wide web (“web”). A web browser executed on a computer does not understand the special scheme and will look for capable registered applications to handle the URI. The provider's website or other Internet location where data is stored electronically provides a login button or a hyperlink. After browsing the provider's website, the user can select, or click, the button or hyperlink displayed at a computer display. The underlying code provides a specially generated URI with said specific scheme, provider's authentication server address and resource path. The browser may provide the generated URI to the corresponding application. The application may establish a secure out-of-band channel connection with the provider using the URI as the endpoint for the connection. The browser has no knowledge of the establishment of this secondary communication channel, and the application, referred to a standalone application, external application, or special application, in some embodiments is required for forming the secondary communication channel. Once the connection is established, the authentication process is performed over the out-of-band secondary communication channel. After authentication using the out-of-band connection, the service transactions may continue in the web browser.

A benefit and novel feature is that embodiments of the present inventive concepts permit a secure authentication to occur as the result of a URI scheme handler. Accordingly, an authentication method is correctly invoked and implemented regardless of the web browser selected by the end-user, rendering the entire secure authentication process browser-agnostic. The system and method in accordance with embodiments may interact with, coexist with, or otherwise work with any web-aware application that is capable of dispatching URI schemes, such as dedicated banking applications for smartphones.

Some embodiments include the handling of special actions upon downloading of a file by a web browser. Web browsers commonly use the Multipurpose Internet Mail Extensions (MIME) standard to perform actions using outside registered applications upon a download of certain kinds of files. For example, when a JPEG file is downloaded, a photo viewer may be opened, or when an audio file is downloaded, a music player is opened. In other embodiments, clicking on a hyperlink in a web site may trigger the download of a special authentication file, or other data element comprising program code. The embodiment may include the registration as a MIME-handler for that type of file. Receipt of the file may subsequently trigger the authentication process at the out-of-band connection.

In one aspect, provided is a computer implemented method of forming a secure data communication exchange between a user computer and a website, comprising: establishing a communication channel between a web browser executed at the user computer and the website; receiving by a standalone application at the user computer a uniform resource identifier (URI) that includes a special scheme; and forming an out of band secondary communication channel to authenticate the user computer, wherein the secondary communication channel is triggered by a specially crafted extension in a user accessed URL.

In another aspect, provided is a system for forming a secure data communication exchange between a user computer and a website, comprising: a hardware processor that establishes a communication channel between a web browser executed at the user computer and the website; a hardware processor that processes a standalone application receiving a uniform resource identifier (URI) that includes a special scheme; and a hardware processor that forms an out of band secondary communication channel to authenticate the user computer, wherein the secondary communication channel is triggered by a specially crafted extension in a user accessed Uniform Resource Locator (URL).

In another aspect, provided is a system for forming a secure data communication exchange between a user computer and a website, comprising at least one computer having computer readable memory and a network interface, the at least one computer programmed to: establish a communication channel between a web browser executed at the user computer and the website; receive by a standalone application a uniform resource identifier (URI) that includes a special scheme; and form an out of band secondary communication channel to authenticate the user computer, wherein the secondary communication channel is triggered by a specially crafted extension in a user accessed Uniform Resource Locator (URL).

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a flow chart illustrating an authentication process between a browser and a service provider using an out-of-band communication channel, in accordance with some embodiments.

FIG. 2 is an illustration of a URI with a special scheme, in accordance with some embodiments.

FIG. 3 is an illustration of a URI with a special filename extension, in accordance with some embodiments.

FIG. 4 is a network schematic illustrating out-of-band channel authentication, in accordance with some embodiments.

### DETAILED DESCRIPTION

Main tasks of modern web browsers are typically for displaying web pages and directing users to new locations of the World Wide Web, or “web”. In addition, web browsers may be configured to play music and video, display documents in special formats, and download files. Web browsers are also enabled to use external software applications to execute special tasks, for example, to open a spreadsheet or a slide presentation. These external applications register their capabilities with the browser so that the browser can display their contents appropriately. A web browser may identify a task based the scheme of the content URI and/or the MIME information about content URI. The MIME information may be presented in the HTTP headers. In many cases the MIME information is determined from the file extension of the file path of the URI.

Web browsers may establish a secure encrypted communication channel with a provider's web site to transmit user credentials, such as username and password, to the provider to authenticate the user. Despite providing a secure channel, a user's credentials can be stolen by malware or a software virus present in the browser that can intercept the password before it is encrypted. Similarly, malicious schemes or attacks may be made against a user, who can be tricked into entering a username and password at a spurious web site that copies the design and style of the provider's website. Therefore, any password based authentication that occurs through a conventional web browser is susceptible to theft or impermissible access. Additionally, good security practices require that users maintain a large list of different passwords for each account, placing an onerous burden on users. Service providers must maintain large databases of username/password pairs, further providing tempting targets for data thieves.

Embodiments of the present inventive concepts provide a system and method for triggering an authentication process from any browser, providing the generated authentication data streams out-of-band without involving that browser, and allowing the use of that browser interface for transactions with the provider after authentication. The responsibility, i.e., execution, for authentication may be provided by a standalone application. Embodiments of the present inventive concepts also provide a novel technique by which the browser hands over the authentication process to an application stored and executed by computer devices. In a preferred embodiment of the inventive concepts, in response to a login request, for example, selecting a button or a link at a user interface of a computer display, the provider's website will provide to the browser a carefully-crafted URI. In particular, a URI may include a special scheme.

In some embodiments, the novel URI may include two special features. First, a special scheme is provided that outputs to the browser data that informs the browser that the URI should be handed to a special application that can handle URIs with this special scheme. Second, a server address, port, path, and/or other destination-related identifiers may be generated that inform the external application of a destination for the endpoint to connect to in order to initiate an out of band communication channel for authentication.

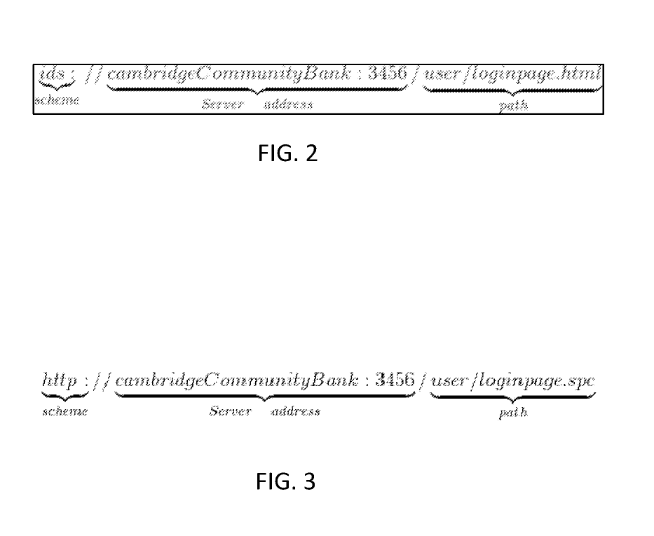

For example, as shown in FIG. 2, the scheme “ids” for example is a special scheme. The browser cannot establish communication with this URI, in particular, since the scheme “ids” is unrecognizable to the browser. The browser may be configured to search for other applications to process this URI.

Similarly, in another example, as shown in FIG. 3, the browser will not have the capability to open a file with the file extension “.spc” and may expect an external program to open the file, since the browser on its own does not recognize the special extension, and may be configured to search for other applications that can indeed recognize the special extension.

In some embodiments, the browser recognizes the special scheme and invokes an external application that is configured to open the file by recognizing the file extension and provides the URI to the application. A browser may execute at least one of two or more methods to identify external applications capable of recognizing schemes not recognized by the browser. In one example, external applications may register with the browser about their capabilities to handle MIMEs or other data descriptors part of received data headers that inform the browser about data received from a URI endpoint. A browser may use a feature of the device's operating system to broadcast a message that includes the MIME. The external application can receive the broadcast and respond to the information in the message. The external application will open a secure encrypted connection, for example, an out-of-band communication channel, outside the browser. The user credentials may be sent over the communication channel. After authentication, the server will redirect the user's browser to an authenticated URI from which the user can perform transactions with the provider.

In another embodiment, the uniquely generated URI from the server has a special file extension as part of a file path. The browser recognizes the file extension and determines appropriate MIME type for the file extension. Based on the MIME type, the browser may invoke the external application and provide the URI to the application. The external application will open a secure encrypted connection with the URI end point outside the browser. In particular, the external application may create an encrypted two-way connection with the provided URI end point. This connection is handled in the background, and is not seen by the browser software. The user credentials will be sent over this communication channel. After authentication, the server will redirect the user's browser to an authenticated URI from which the user can do transactions with the provider server.

In another embodiment, the external application can communicate a prearranged secret to the user, such as a photo the user has previously selected for that provider site. The user will verify this secret before providing the user credentials to the application to forward to the provider. This will prevent spoofing by malware as the legitimate external application to perform credential transfer with the provider. The external application can also ask the provider to provide credentials to verify that the application is communicating with the correct web site. The application will send user credentials over the out-of-band communication channel only after the provider's credentials have been verified.

In some embodiments, the external applications may not output a user password to the provider. Instead, the application may output a proof of the presence of correct user password to the provider. This can be accomplished by the use of asymmetric public-private keys. During account setup, the application and the provider will exchange their public keys, respectively. One side of an encrypted channel may include the user computer, and the other may include the authentication server. The key algorithms may be of the standalone application on the user side, and part of the authentication server on the provider side. During authentication, the provider will send a challenge word to the application. The application will use the password to unlock the user's private key to encrypt the challenge word. The encrypted challenge word will be decrypted and verified by the provider using the application's public key. Likewise, the application can verify the provider using a challenge word. For example, the application will choose a one-time challenge word and send it to the provider. The provider will encrypt the word using its own private key and send the encrypted challenge word to the application. The application can decrypt the received message using the provider's public key and confirm the identity of the provider. The public/private key pair used by the application can be different for each provider.

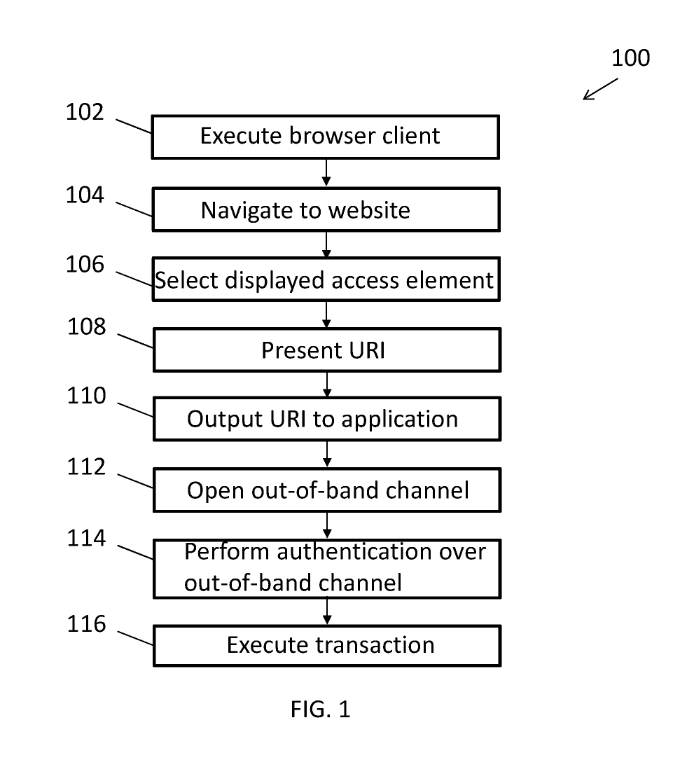

FIG. 1 is a flow chart illustrating an authentication process 100 between a browser and a service provider using an out-of-band communication channel, in accordance with some embodiments. Some or all of the process 100 may be performed at special-purpose devices, which may include a processor for executing elements of the process 100 and/or storage for storing program code or the like used by execution by the processor.

At block 102, a browser client is executed at a computer. In some embodiments, the browser client includes program code that is stored in a memory and is executed by a computer processor.

At block 104, the user may navigate the Internet and/or other communication network to the website of a provider (for example the home page of an online store), more specifically, to a computer server or the like that stores data for executing elements of the website. The provider may be a service provider or other provider of information, merchandise, services, and/or anything of value to the user, for example, online banks, social networking sites are all providers.

At block 106, the user can select a special access element that is displayed from the provider's website on the user's computer display. For example, the access element may be a hyperlink, button, field, or other displayed item that can selected by a mouse pointer, tactile input via touchscreen, or other activation technique. The hyperlink can be highlighted text on a browser which redirects a user on click to a new web page. The button can be a login button displayed on website.

At block 108, the client side program code, for example, included in the displayed web page by the provider's web server provides a specially crafted URI to the browser. In some embodiments, the URI has a specific scheme, for example, a Multipurpose Internet Mail Extensions (MIME) type or related Internet standard for an extension.

At block 110, the browser outputs the URI to a specific software application. The application may be on the same device as the browser or on a device to which the user has simultaneous access.

At block 112, the application may use the URI as an address to open an out-of-band channel 206 to the provider's authentication computer server at which the website is located. The authentication computer server can also be on a different computer than the provider's web server. The connection can be to a different authentication server every time or can be to a different port on the same authentication server. The connection end point can be randomized.

At block 114, an authentication technique is performed over the out-of-band channel 206, for example, described herein.

After authentication between the application and the authentication server, the authentication server will communicate to the web server about the authentication 212. The web server will now consider this as successful login of the user.

At block 116, after authentication, a transaction may be performed. For example, the provider's webserver will allow access to a bank account or allow access to social networking website.

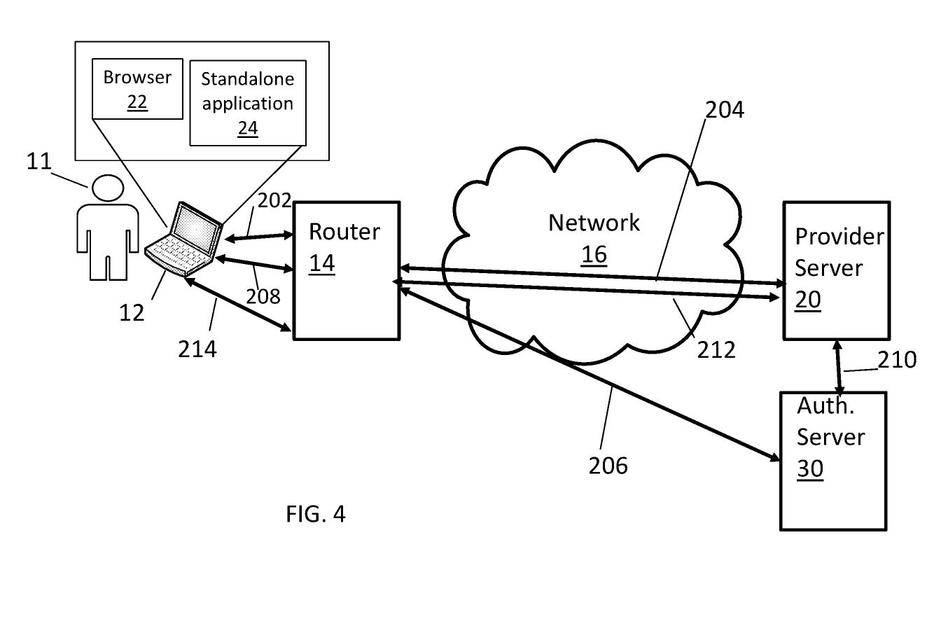

FIG. 4 is a network schematic illustrating out-of-band channel authentication, in accordance with some embodiments. Elements of the steps illustrated in FIG. 4 may be the same as or similar to those described with reference to the authentication process 100 and are not repeated due to brevity.

A user 11 may execute a browser on a computer 12. In doing so, a communication path, or browser connection 202, 204, may be formed between a web location identified in a URL entered at the browser 22, for example, a service provider website. The user computer 12, router 14 and/ or other communications devices such as network switches, WiFi access points, servers, and so on may form the communication path between the computer 12 and the provider server 20 according to well-known internet protocols and/or other communication transmission techniques. At the website executed from the provider server 20, the server 20 may require authentication, for example, a login field where the user must enter a username and password. When the user tries to log into the website, for example, in response to a login request, the hyperlink underlying the browser element used for login will provide a special MIME that includes a URL to the browser. The browser will transfer the URL in the MIME to a registered application or broadcast the MIME using the features of the computer's operating system so that any application listening for broadcasts can receive them.

A registered application or an application that receives the broadcasted MIME and understands the MIME 24 is executed to process the URL. The application 24 opens a secondary communication channel (206, 208) with an authentication server 30 for authentication. In some embodiments, the secondary communication channel is triggered by a specially crafted MIME in a user accessed URL. In some embodiments, the secondary communication channel is triggered by a trigger for opening the secondary channel, and wherein the trigger includes a specially crafted scheme that is part of the URI. In other words, the standalone application generates the secondary communication channel independently, and the browser triggers the standalone application. Thus, the secondary channel is created without using the browser.

An authentication status (210) is exchanged between the provider server 20 and an authentication server 30. The second channel 206, 208 may be opened in a background process. The second channel 206, 208 may be unknown to the browser.

The provider server 20 allows the user to access (212, 214) the resource at the provider server 20 with the browser 22 at the user computer 12. For example, the provider's web server will allow access to a bank account or allow access to social networking website.

As will be appreciated by one skilled in the art, aspects of the disclosed system and method for determining a sequence for a plurality of tasks may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, radio frequency, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more hardware processors of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

While the invention has been shown and described with reference to specific preferred embodiments, it should be understood by those skilled in the art that various changes in form and detail may be made therein without departing from the spirit and scope of the invention as defined by the following claims.

1. A computer implemented method of forming a secure data communication exchange between a user computer and a website, comprising:
establishing a communication channel between a web browser executed at the user computer and the website;
receiving by a standalone application at the user computer a uniform resource identifier (URI) that includes a special scheme; and
forming an out of band secondary communication channel to authenticate the user computer, wherein the secondary communication channel is triggered by a specially crafted extension in a user accessed Uniform Resource Locator (URL).

2. The computer implemented method of claim 1, wherein the secondary communication channel is triggered by a trigger for opening the secondary channel, and wherein the trigger includes a specially crafted scheme that is part of the URI.

3. The computer implemented method of claim 1, wherein the secondary communication channel connects to a different endpoint on the server.

4. The computer implemented method of claim 1, wherein the secondary communication channel connects to a randomly chosen end point at the same authentication server for each authentication.

5. The computer implemented method of claim 1, wherein the standalone application generates the secondary communication channel independently, and wherein the browser triggers the standalone application, wherein an attempt is made to access resources on a server using the web browser and wherein the secondary communication channel is created without using the browser.

6. The computer implemented method of claim 1, wherein the communication over the secondary communication channel is encrypted.

7. The computer implemented method of claim 6, wherein the encryption is generated using asymmetric public/private key algorithms.

8. The computer implemented method of claim 1, wherein the specially crafted extension is a Multipurpose Internet Mail Extensions (MIME) extension.

9. The computer implemented method of claim 1, wherein the special scheme is provided that outputs to the browser data that informs the browser that the URI should be handed to the application that can handle URIs with the special scheme.

10. The computer implemented method of claim 9, wherein a server address, port and path are identified and generated that inform the application of a destination for the endpoint to connect to in order to initiate the secondary communication channel for authentication.

11. The computer implemented method of claim 1, further comprising: recognizing by the web browser the special scheme, invoking the external application, and providing the URI to the external application.

12. The computer implemented method of claim 1, wherein the web browser cannot open a file having the special extension, and searches for other applications that recognize the special extension.

13. The computer implemented method of claim 1, the standalone application registers with the web browser about its capability to recognize and process the specially crafted extension.

14. The computer implemented method of claim 1, further comprising after authentication, redirecting by the provider server the web browser to an authenticated URI from which the user can perform transactions with the provider.

15. A system for forming a secure data communication exchange between a user computer and a website, comprising:
a hardware processor that establishes a communication channel between a web browser executed at the user computer and the website;
a hardware processor that processes a standalone application receiving a uniform resource identifier (URI) that includes a special scheme; and
a hardware processor that forms an out of band secondary communication channel to authenticate the user computer, wherein the secondary communication channel is triggered by a specially crafted extension in a user accessed Uniform Resource Locator (URL).

16. A system for forming a secure data communication exchange between a user computer and a website, comprising at least one computer having computer readable memory and a network interface, the at least one computer programmed to:
establish a communication channel between a web browser executed at the user computer and the web site;
receive by a standalone application a uniform resource identifier (URI) that includes a special scheme; and
form an out of band secondary communication channel to authenticate the user computer, wherein the secondary communication channel is triggered by a specially crafted extension in a user accessed Uniform Resource Locator (URL).
